(19) United States
(12) Patent Application Publication
(10) Pub. No.: US 2017/0331550 A1
(43) Pub. Date: Nov. 16, 2017

(54) PHOTONIC-CHIP-BASED OPTICAL SPECTRUM ANALYZER

(71) Applicant: Coriant Advanced Technology, LLC, New York, NY (US)

(72) Inventors: Yang Liu, Elmhurst, NY (US); Yangjin Ma, Brooklyn, NY (US); Michael J. Hochberg, New York, NY (US)

(21) Appl. No.: 15/151,797

(22) Filed: May 11, 2016

(51) Int. Cl. H04B 10/079; G01J 3/45; H04B 10/516; H04B 10/572

(52) U.S. Cl. CPC H04B 10/07957; H04B 10/572; G01J 3/45; H04B 10/516

(57) ABSTRACT

An optical spectrum analyzer (OSA) for measuring an optical spectrum of an input optical signal in a measurement wavelength range is provided. The OSA comprises a modulator, an integrated optical filter, and a photodetector. The modulator modulates the input optical signal by applying a dither modulation to facilitate detection and noise rejection. The integrated optical filter, which may include a ring resonator system, is sequentially tunable to selectively transmit each wavelength of the modulated optical signal in the measurement wavelength range. The photodetector sequentially detects each wavelength of the modulated optical signal in the measurement wavelength range to provide a representative output electrical signal.

### FIELD OF THE INVENTION

The present invention relates to an optical spectrum analyzer (OSA). More particularly, the present invention relates to a photonic-chip-based OSA.

### BACKGROUND OF THE INVENTION

Optical spectrum analyzers (OSAs) are used to measure optical spectra in a measurement wavelength (or frequency) range, typically, by measuring optical power as a function of wavelength (or frequency). Most OSAs use optical filters to resolve each wavelength in the measurement wavelength range. For example, a chip-scale OSA using a Fabry-Perot filter with a variable mirror spacing and a nanooptic filter array is described in U.S. Pat. No. 7,426,040 to Kim et al., filed on Aug. 19, 2005, which is incorporated herein by reference. Many OSAs use tunable optical filters that can be tuned to resolve each wavelength in the measurement wavelength range.

In photonic chips, ring resonator systems with various configurations may be used as tunable optical filters. For example, double-ring resonator systems suitable for use as tunable optical filters for demultiplexing applications are described in “Theoretical Analysis of Triple-Coupler Ring-Based Optical Guided-Wave Resonator” by Barbarossa et al., Journal of Lightwave Technology, 13, 148-157, 1995; in “Vernier Operation of Fiber Ring and Loop Resonators” by Ja, Fiber and Integrated Optics, 14, 225-244, 1995; and in S. Suzuki, K. Oda, and in “Integrated-Optic Double-Ring Resonators with a Wide Free Spectral Range of 100 GHz” by Hibino, Journal of Lightwave Technology, 8, 1766-1771, 1995; each of which is incorporated herein by reference. The use of two cascaded ring resonators as a sensor in a photonic chip has also been described in “Experimental characterization of a silicon photonic biosensor consisting of two cascaded ring resonators based on the Vernier-effect and introduction of a curve fitting method for an improved detection limit” by Claes et al., Optics Express, 18, pp. 22747-22761, 2010, which is incorporated herein by reference.

### SUMMARY OF THE INVENTION

Accordingly, an aspect of the present invention relates to an optical spectrum analyzer (OSA) for measuring an optical spectrum of an input optical signal in a measurement wavelength range, the OSA comprising: a modulator for modulating the input optical signal by applying a dither modulation to facilitate detection and noise rejection; an integrated optical filter that is sequentially tunable to selectively transmit each wavelength of the modulated optical signal in the measurement wavelength range; and a photodetector for sequentially detecting each wavelength of the modulated optical signal in the measurement wavelength range to provide a representative output electrical signal.

Another aspect of the present invention relates to a method of measuring an optical spectrum of an input optical signal in a measurement wavelength range, the method comprising: providing an OSA comprising: a modulator for modulating the input optical signal by applying a dither modulation to facilitate detection and noise rejection; an integrated optical filter that is sequentially tunable to selectively transmit each wavelength of the modulated optical signal in the measurement wavelength range; and a photodetector for sequentially detecting each wavelength of the modulated optical signal in the measurement wavelength range to provide a representative output electrical signal; modulating, by means of the modulator, the input optical signal by applying a dither modulation to facilitate detection and noise rejection; sequentially tuning the integrated optical filter to selectively transmit each wavelength of the modulated optical signal in the measurement wavelength range; and sequentially detecting, by means of the photodetector, each wavelength of the modulated optical signal in the measurement wavelength range to provide a representative output electrical signal.

### BRIEF DESCRIPTION OF THE DRAWINGS

Numerous exemplary embodiments of the present invention will now be described in greater detail with reference to the accompanying drawings wherein:

FIG. 1A is a schematic illustration of an optical spectrum analyzer (OSA);

FIG. 1B is a schematic illustration of two cascaded tunable ring resonators in the OSA of FIG. 1A;

FIG. 2 is a schematic illustration of two coupled tunable ring resonators;

FIG. 3 is a plot of transmission spectra of a first tunable ring resonator, a second tunable ring resonator, and a ring resonator system;

FIG. 4 is a plot of transmission spectra of a tunable ring resonator of as a function of second voltage; and;

FIG. 5 is a plot of an output of an OSA when used to measure optical spectra of input optical signals from a tunable laser tuned to wavelengths of 1540 nm, 1550 nm, 1560 nm, and 1570 nm, respectively.

### DETAILED DESCRIPTION OF THE INVENTION

We describe herein a photonic-chip-based optical spectrum analyzer (OSA) for measuring an optical spectrum of an input optical signal in a measurement wavelength (or frequency) range, typically by measuring optical power as a function of wavelength (or frequency) for the input optical signal. The input optical signal may be a known or unknown optical signal.

In some embodiments, the measurement wavelength range encompasses the C-band, i.e., a wavelength range of about 1530 nm to about 1565 nm. Some embodiments of the OSA may be used for sensing or for optical channel monitoring. The OSA may also be used within an optical network.

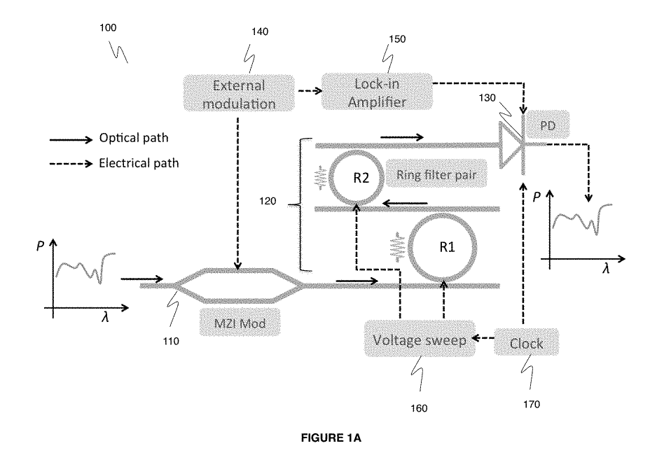

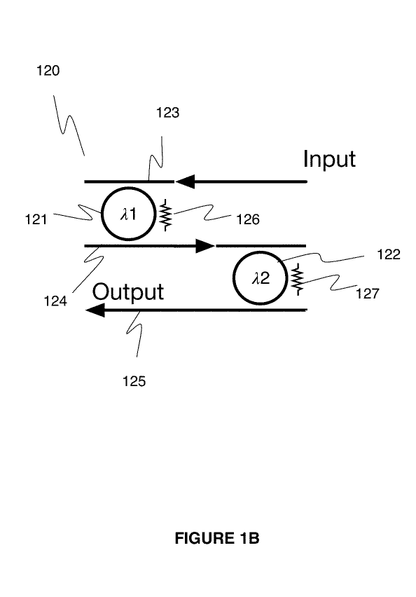

With reference to FIG. 1, an exemplary embodiment of the OSA 100 comprises a photonic chip, which includes an integrated modulator 110, an integrated optical filter comprising a ring resonator system 120, and an integrated photodetector 130. Although the integrated optical filter in the illustrated embodiment comprises a ring resonator system 120, in other embodiments, the integrated optical filter could be any suitable type of integrated optical filter that is tunable over the measurement wavelength range. In yet other embodiments, the integrated optical filter could be replaced by a non-tunable element that provides different optical paths for different wavelengths, such as a fixed-wavelength filter, an arrayed waveguide grating (AWG), or an echelle grating. Such a non-tunable element could be used together with an array of photodetectors.

In the illustrated embodiment, the modulator 110, the ring resonator system 120, and the photodetector 130 are all monolithically integrated on the photonic chip. In other embodiments, an off-chip modulator and/or an off-chip photodetector could be used. The photonic chip may be fabricated using any suitable material system. Typically, the photonic chip is fabricated using a silicon-on-insulator (SOI) material system. Alternatively, the photonic chip could be fabricated using a silica-on-silicon material system, a silicon nitride material system, a silicon oxynitride material system, or a III-V material system, for example.

The OSA 100 also comprises a signal generator 140, also known as a pattern generator, a lock-in amplifier 150, a voltage sweep module 160, and a clock 170. In some embodiments, the voltage sweep module 160 and the clock 170 are implemented in a controller, e.g., a microcontroller or a computer.

In some embodiments, the signal generator 140 and/or lock-in amplifier 150 can be replaced by microelectronic chips, in which dither signals can be generated in digital and converted to analog through a digital-to-analog converter (DAC) at a certain frequency, and the same frequency can be extracted from the integrated photodetector 130 with an analog-to-digital converter (ADC) and digital filtering.

The input optical signal is launched into the integrated modulator 110, which modulates the input optical signal by applying a dither modulation to facilitate detection and noise rejection, thereby improving the signal-to-noise ratio (SNR). In the embodiment of FIG. 1, the integrated modulator 110 is a Mach-Zehnder interferometer (MZI), which is balanced to allow wideband performance, so that the integrated modulator 110 is able to modulate the input optical signal over the entire measurement wavelength range. In general, the integrated modulator can be any kind of electro-optical modulator, provided that it performs over the entire measurement wavelength range. In some embodiments, the integrated modulator can be an electro-absorption modulator, a ring modulator, an amplitude modulator, or a phase modulator. If the integrated modulator is a phase modulator, a downstream detector that has a phase-to-amplitude converter may be required. In an exemplary embodiment, a phase modulator may be followed by a wavelength discriminator, followed by a differential delay line or an unbalanced MZI, followed by a pair of photodetectors.

The signal generator 140 simultaneously provides a modulation electrical signal to the integrated modulator 110 and to the lock-in amplifier 150. The integrated modulator 110 modulates the input optical signal in response to the modulation electrical signal, and the lock-in amplifier 150 uses the modulation electrical signal to extract the output electrical signal from the integrated photodetector 130 from noise, e.g., environmental noise.

The modulated optical signal then enters the ring resonator system 120, which includes at least two tunable ring resonators. The tunable ring resonators are, typically, formed as waveguide loops that are circular, oval, or racetrack-shaped. The ring resonator system 120 may also include at least two integrated heaters, which may be formed as sections of doped waveguide inside each tunable ring resonator, or as metal resistors on top of each tunable ring resonator.

In the embodiment of FIG. 1, the ring resonator system 120 includes two cascaded tunable ring resonators, a first tunable ring resonator 121 and a second tunable ring resonator 122. An input waveguide 123 is coupled to the first tunable ring resonator 121, an intermediate waveguide 124 is coupled to the first tunable ring resonator 121 and the second tunable ring resonator 122, and an output waveguide 125 is coupled to the second tunable ring resonator 122. The first tunable ring resonator 121 and the second tunable ring resonator 122 are cascaded via the intermediate waveguide 124. The ring resonator system 120 also includes a first integrated heater 126 for heating the first tunable ring resonator 121 in response to a first voltage, and a second integrated heater 127 for heating the second tunable ring resonator 122 in response to a second voltage. An on-chip temperature sensor, such as an integrated temperature sensor of the type disclosed in U.S. Patent Application Publication No. 2016/0124251 to Zhang et al., published on May 5, 2016, which is incorporated herein by reference, may be used to sense the temperature of each tunable ring resonator.

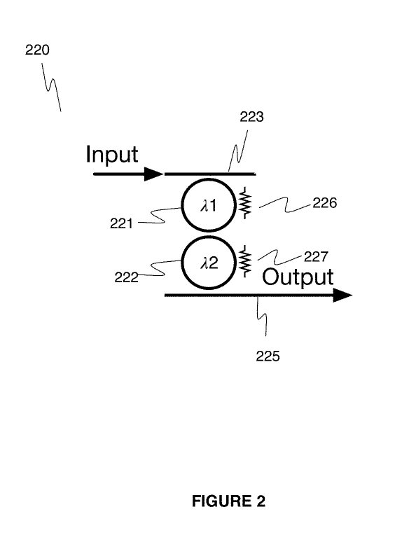

With reference to FIG. 2, in an alternative embodiment, the ring resonator system 220 includes two coupled tunable ring resonators, a first tunable ring resonator 221 and a second tunable ring resonator 222. An input waveguide 223 is coupled to the first tunable ring resonator 221, and an output waveguide 225 is coupled to the second tunable ring resonator 222. The first tunable ring resonator 221 and the second tunable ring resonator 222 are directly coupled. The ring resonator system 220 also includes a first integrated heater 226 for heating the first tunable ring resonator 221 in response to a first voltage, and a second integrated heater 227 for heating the second tunable ring resonator 222 in response to a second voltage.

In other embodiments, the ring resonator system may include more than two tunable ring resonators in a cascaded or coupled configuration, each provided with an integrated heater.

With reference again to FIG. 1, the first tunable ring resonator 121 and the second tunable ring resonator 122 serve as tunable optical filters. The transmission spectrum of the first tunable ring resonator 121 includes a first set of resonance peaks, which have a first spectral linewidth, i.e., a full width at half maximum (FWHM), and which are separated by a first free spectral range (FSR). Likewise, the transmission spectrum of the second tunable ring resonator 122 includes a second set of resonance peaks, which have a second spectral linewidth and which are separated by a second FSR.

When a first voltage is applied to the first integrated heater 126 to heat the first tunable ring resonator 121, the first set of resonance peaks shift collectively, but the first FSR does not change. When a second voltage is applied to the second integrated heater 127 to heat the second tunable ring resonator 122, the second set of resonance peaks shift collectively, but the second FSR does not change. By adjusting the first voltage applied to the first integrated heater 126, the first tunable ring resonator 121 can be tuned, and by adjusting the second voltage applied to the second integrated heater 127, the second tunable ring resonator 122 can be tuned. Typically, two power supplies, e.g., direct current (DC) power supplies, are used to apply the first voltage to the first integrated heater 126 and the second voltage to the second integrated heater 127, respectively.

Usually, the FSR of a single tunable ring resonator is small, resulting in a narrow tunable range, e.g., a tunable range much narrower than the C-band. In order to achieve a larger FSR and a wider tunable range, e.g., a tunable range encompassing the entire C-band, two or more tunable ring resonators having slightly different radii may be cascaded or coupled to exploit the Vernier effect, as explained hereinbelow.

In the embodiment of FIG. 1, the first tunable ring resonator 121 and the second tunable ring resonator 122 have different radii, e.g., 8 μm and 10 μm, and, therefore, different FSRs. Typically, on an SOI platform, the first tunable ring resonator 121 and the second tunable ring resonator 122 have radii of about 5 μm to about 20 μm. When the input optical signal is launched into the ring resonator system 120, via the input waveguide 123, the input optical signal is first filtered by the first tunable ring resonator 121. The output from the first tunable ring resonator 121 is then coupled into the second tunable ring resonator 122, via the intermediate waveguide 124 in the embodiment of FIG. 1, and filtered by the second tunable ring resonator 122. The output from the second tunable ring resonator 122 is received via the output waveguide 125 and detected by the integrated photodetector 130. When an absolute difference between the first FSR and the second FSR is large compared to the first linewidth and the second linewidth, the transmission spectrum of the ring resonator system 120 will include peaks where the first and second sets of resonance peaks coincide, but non-coincident peaks in the first and second sets of resonance peaks will be suppressed.

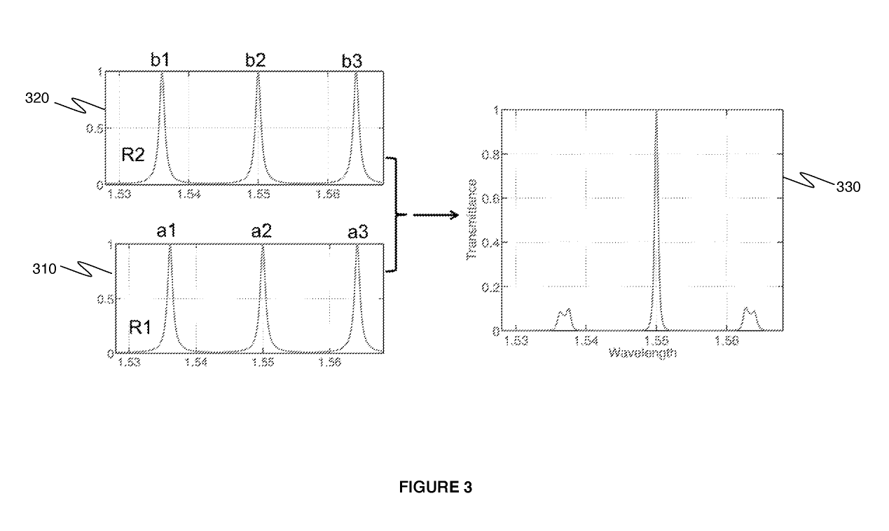

For example, with reference to FIG. 3, if the center peaks, a2 and b2, in the transmission spectrum 310 of the first tunable ring resonator and the transmission spectrum 320 of the second tunable ring resonator are aligned, the ring resonator system will output a transmission spectrum 330 including the center peak, in which the non-aligned peaks are suppressed. Moreover, peak a2 does not necessarily have to be aligned with peak b2, but can be tuned to align with peak b3 or b1. Likewise, peaks a1 and a3 can also be aligned with peaks b1, b2, and b3. Accordingly, the tunable range of the ring resonator system may be dramatically increased by the Vernier effect.

With reference again to FIG. 1, because of the Vernier effect, the ring resonator system 120 has an extended FSR corresponding to a least common multiple of the first FSR and the second FSR, i.e., a smallest number that is a multiple of both the first FSR and the second FSR. The first FSR and the second FSR are selected to ensure that the least common multiple of the first FSR and the second FSR is greater than the measurement wavelength range of the OSA 100, and to ensure that the absolute difference between the first FSR and the second FSR is greater than the first spectral linewidth and greater than the second spectral linewidth. Typically, the least common multiple of the first FSR and the second FSR is greater than about 50 nm, and the absolute difference between the first FSR and the second FSR is greater than about 0.5 nm.

Accordingly, the transmission spectrum of the ring resonator system includes only one peak in the measurement wavelength range of the OSA 100 for a given pair of values of the first voltage and the second voltage. By cooperatively adjusting the first and second voltages, by means of the voltage sweep module 160, the peak can be shifted in wavelength to scan over the measurement wavelength range. In other words, the ring resonator system 120 can be tuned to resolve each wavelength in the measurement wavelength range.

Thus, when input light is launched into the ring resonator system 120, the ring resonator system 120 is sequentially tunable to selectively transmit each wavelength of the input light in the measurement wavelength range of the OSA 100 by cooperatively tuning the first tunable ring resonator 121 and the second tunable ring resonator 122. Typically, the first tunable ring resonator 121 and the second tunable ring resonator 122 are pre-calibrated by measuring transmission spectra of the first tunable ring resonator 121 as a function of the first voltage, and by measuring transmission spectra of the second tunable ring resonator 122 as a function of the second voltage. An absolute wavelength standard or a laser of known wavelength may be used as a wavelength reference. Pairs of values of the first voltage and the second voltage that result in coincident resonance peaks at each wavelength in the measurement wavelength range can be identified. Thereby, pairs of values of the first voltage and the second voltage that result in selective transmission by the ring resonator system 120 at each wavelength in the measurement wavelength range can be predetermined.

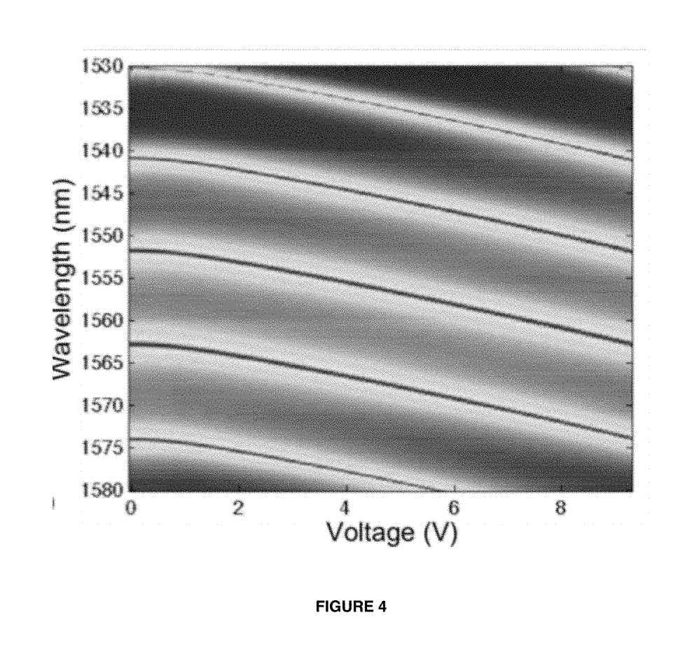

For example, with respect to FIG. 4, a tunable laser was used to measure transmission spectra of an exemplary embodiment of a tunable ring resonator in the measurement wavelength range as a function of voltage. Transmission spectra were collected with voltage steps of 20 mV in a voltage range of 0 V to 9.3 V. The resonance peaks collectively shifted by a wavelength step of about 0.02 nm per voltage step for a total wavelength shift of about 12 nm over the voltage range.

With reference again to FIG. 1, once calibrated, the OSA 100 is programmable for real-time measurement of optical spectra. The voltage sweep module 160 sequentially adjusts the first voltage and the second voltage to the predetermined pairs of values of the first voltage and the second voltage, and thereby tunes the ring resonator system 120 to scan the measurement wavelength range. The clock 170 synchronizes the integrated photodetector 130 with the voltage sweep module 160, so that the integrated photodetector 130 sequentially detects each wavelength of the optical signal received from the ring resonator system 120 as the measurement wavelength range is scanned. The integrated photodetector 130 provides a representative output electrical signal for each wavelength, from which the optical spectrum can be re-formed.

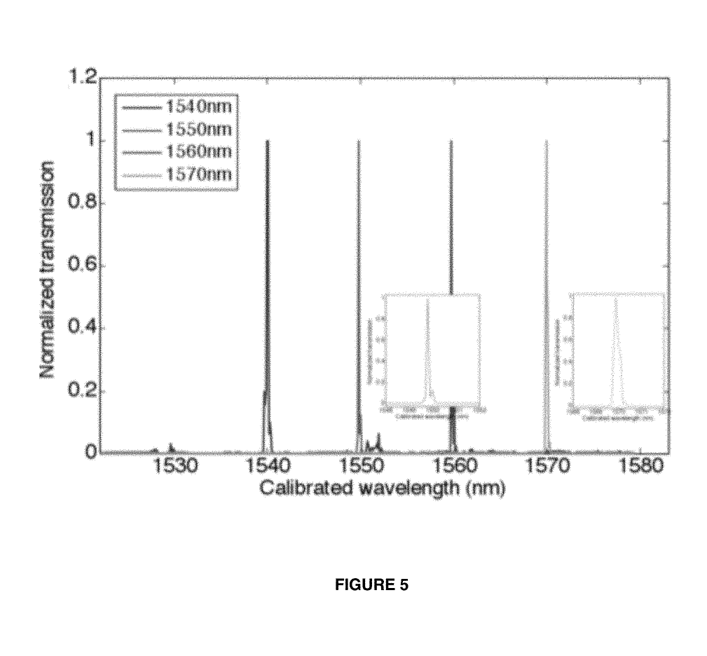

For example, with respect to FIG. 5, an exemplary embodiment of an OSA was used to separately measure optical spectra of input optical signals from a tunable laser tuned to wavelengths of 1540 nm, 1550 nm, 1560 nm, and 1570 nm, respectively. To measure each optical spectrum, the ring resonator system was sequentially tuned to selectively transmit each wavelength of the input optical signal in the measurement wavelength range, with a wavelength step of about 0.02 nm, by sequentially adjusting the first voltage and the second voltage to predetermined pairs of values of the first voltage and the second voltage. Each optical spectrum includes a single peak at the laser wavelength. The resolution of the OSA is about 0.1 nm.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. An optical spectrum analyzer (OSA) for measuring an optical spectrum of an input optical signal in a measurement wavelength range, the OSA comprising:
a modulator for modulating the input optical signal by applying a dither modulation to facilitate detection and noise rejection;
an integrated optical filter that is sequentially tunable to selectively transmit each wavelength of the modulated optical signal in the measurement wavelength range; and
a photodetector for sequentially detecting each wavelength of the modulated optical signal in the measurement wavelength range to provide a representative output electrical signal.

2. The OSA of claim 1, wherein the modulator is an integrated modulator.

3. The OSA of claim 2, wherein the integrated modulator is a balanced Mach-Zehnder interferometer (MZI).

4. The OSA of claim 1, further comprising:
a lock-in amplifier for sequentially extracting the representative output electrical signal for each wavelength of the modulated optical signal selected by the integrated optical filter from noise.

5. The OSA of claim 1, wherein the photodetector is an integrated photodetector.

6. The OSA of claim 1, wherein the integrated optical filter comprises:
a ring resonator system comprising at least two tunable ring resonators.

7. The OSA of claim 6, wherein the ring resonator system comprises more than two tunable ring resonators.

8. The OSA of claim 6, wherein the at least two tunable ring resonators comprise:
a first tunable ring resonator having a first free spectral range (FSR) and a first spectral linewidth; and
a second tunable ring resonator having a second FSR and a second spectral linewidth;
wherein a least common multiple of the first FSR and the second FSR is greater than the measurement wavelength range, and wherein an absolute difference between the first FSR and the second FSR is greater than the first spectral linewidth and greater than the second spectral linewidth;
such that the ring resonator system is sequentially tunable to selectively transmit each wavelength of the modulated optical signal in the measurement wavelength range by cooperatively tuning the first tunable ring resonator and the second tunable ring resonator.

9. The OSA of claim 8, wherein the ring resonator system further comprises:
an intermediate waveguide coupled to the first tunable ring resonator and the second tunable ring resonator; and
wherein the first tunable ring resonator and the second tunable ring resonator are cascaded via the intermediate waveguide.

10. The OSA of claim 8, wherein the first tunable ring resonator and the second tunable ring resonator are directly coupled.

11. The OSA of claim 8, wherein the ring resonator system further comprises:
a first integrated heater for heating the first tunable ring resonator in response to a first voltage to tune the first tunable ring resonator; and
a second integrated heater for heating the second tunable ring resonator in response to a second voltage to tune the second tunable ring resonator.

12. The OSA of claim 11, further comprising:
a voltage sweep module for cooperatively adjusting the first voltage and the second voltage to cooperatively tune the first tunable ring resonator and the second tunable ring resonator.

13. The OSA of claim 12, wherein the voltage sweep module is for cooperatively adjusting the first voltage and the second voltage by:
sequentially adjusting the first voltage and the second voltage to predetermined pairs of values of the first voltage and the second voltage that result in selective transmission by the ring resonator system at each wavelength in the measurement wavelength range.

14. A method of measuring an optical spectrum of an input optical signal in a measurement wavelength range, the method comprising:
providing an optical spectrum analyzer (OSA) comprising:
a modulator for modulating the input optical signal by applying a dither modulation to facilitate detection and noise rejection;
an integrated optical filter that is sequentially tunable to selectively transmit each wavelength of the modulated optical signal in the measurement wavelength range; and
a photodetector for sequentially detecting each wavelength of the modulated optical signal in the measurement wavelength range to provide a representative output electrical signal;
modulating, by means of the modulator, the input optical signal by applying a dither modulation to facilitate detection and noise rejection;
sequentially tuning the integrated optical filter to selectively transmit each wavelength of the modulated optical signal in the measurement wavelength range; and
sequentially detecting, by means of the photodetector, each wavelength of the modulated optical signal in the measurement wavelength range to provide a representative output electrical signal.

15. The method of claim 14, wherein the modulator is an integrated modulator.

16. The method of claim 14, further comprising:
sequentially extracting the representative output electrical signal for each wavelength of the modulated optical signal selected by the tunable optical filter from noise.

17. The method of claim 14, wherein the photodetector is an integrated photodetector.

18. The method of claim 14, wherein the integrated optical filter comprises:
a ring resonator system comprising at least two tunable ring resonators.

19. The OSA of claim 18, wherein the at least two tunable ring resonators comprise:
a first tunable ring resonator having a first free spectral range (FSR) and a first spectral linewidth; and
a second tunable ring resonator having a second FSR and a second spectral linewidth;
wherein a least common multiple of the first FSR and the second FSR is greater than the measurement wavelength range, and wherein an absolute difference between the first FSR and the second FSR is greater than the first spectral linewidth and greater than the second spectral linewidth;
such that the ring resonator system is sequentially tunable to selectively transmit each wavelength of the modulated optical signal in the measurement wavelength range by cooperatively tuning the first tunable ring resonator and the second tunable ring resonator;
and wherein sequentially tuning the integrated optical filter to selectively transmit each wavelength of the modulated optical signal in the measurement wavelength range comprises:
sequentially tuning the ring resonator system to selectively transmit each wavelength of the modulated optical signal in the measurement wavelength range by cooperatively tuning the first tunable ring resonator and the second tunable ring resonator.

20. The method of claim 19, wherein the ring resonator system further comprises:
a first integrated heater for heating the first tunable ring resonator in response to a first voltage to tune the first tunable ring resonator; and
a second integrated heater for heating the second tunable ring resonator in response to a second voltage to tune the second tunable ring resonator; and
wherein cooperatively tuning the first tunable ring resonator and the second tunable ring resonator comprises:
heating, by means of the first integrated heater, the first tunable ring resonator in response to the first voltage to tune the first tunable ring resonator; and
heating, by means of the second integrated heater, the second tunable ring resonator in response to the second voltage to tune the second tunable ring resonator.

21. The method of claim 20, wherein cooperatively tuning the first tunable ring resonator and the second tunable ring resonator further comprises:
cooperatively adjusting the first voltage and the second voltage to cooperatively tune the first tunable ring resonator and the second tunable ring resonator.

22. The method of claim 21, further comprising:
predetermining pairs of values of the first voltage and the second voltage that result in selective transmission by the ring resonator system at each wavelength in the measurement wavelength range;
wherein cooperatively adjusting the first voltage and the second voltage to cooperatively tune the first tunable ring resonator and the second tunable ring resonator comprises:
sequentially adjusting the first voltage and the second voltage to the predetermined pairs of values of the first voltage and the second voltage.

23. The method of claim 22, wherein predetermining pairs of values of the first voltage and the second voltage comprises:
measuring transmission spectra of the first tunable ring resonator as a function of the first voltage; and
measuring transmission spectra of the second tunable ring resonator as a function of the second voltage.
